(19) United States
(12) Patent Application Publication
(10) Pub. No.: US 2005/0138542 A1
(43) Pub. Date: Jun. 23, 2005

(54) Efficient small footprint XML parsing

(76) Inventors: Bryan Y. Roe, Washington, DC (US); Ylian Saint-Hilaire, Hillsboro, OR (US); Nelson F. Kidd, Camas, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/741,299

(22) Filed: Dec. 18, 2003

(51) Int. Cl. G06F 15/00

(52) U.S. Cl. 715/513

(57) ABSTRACT

A system and method for parsing XML strings. According to the method, an input string is transformed into linked list node structures. The syntax of the input string is verified. Using the linked list node structures that include attributes, linked list attribute structures are created. Using the reserved pointers from the linked list node structures, data segments within the input string are obtained. The linked list node structures and attribute structures are freed. Freeing the linked list node structures and attribute structures deletes the linked list node and attribute structures while maintaining pointers, defined within the linked list node and attribute structures, into the input string that define data and attributes within each of a plurality of elements contained within the input string.

### FIELD OF THE INVENTION

The present invention is generally related to Internet technology. More particularly, the present invention is related to a system and method for XML (Extensible Markup Language) parsing.

### DESCRIPTION

Extended Wireless PC (personal computer), digital home, and digital office initiatives are all based upon standard protocols that utilize XML (Extensible Markup Language). Traditional XML parsers are complex and are not very suitable for embedded devices. Many device vendors are having difficulty implementing these standard protocols into their devices because of the complexity and overhead of XML parsing. For example, current XML parsers may be classified into two categories: a DOM (Document Object Model) and a SAX (Simple API (Application Programming Interface) for XML).

DOM parsers operate by parsing an XML string and returning a collection of XML elements. Each element contains information about a particular element in an XML document. In order for this to be possible, all of the information must be copied into the returned structure. This results in a lot of memory overhead.

SAX parsers are much simpler in design. They are stateless forward parsers. That is, the application using the parser must contain the logic for maintaining state and any data passed to the application must be copied into the application's memory buffer. Although the SAX parser is a much simpler design than the DOM parser, the SAX parser still requires a lot of memory overhead.

Thus, what is needed is a system and method for parsing XML that does not require a lot of memory overhead. What is also needed is a system and method for parsing XML that is simple in design, yet requires a small footprint. What is further needed is a system and method for parsing XML that is simple in design and requires little overhead, thereby enabling device vendors to incorporate XML parsing into their devices.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary system for parsing XML strings according to an embodiment of the present invention.

FIG. 2A is a flow diagram describing an exemplary method for parsing XML strings according to an embodiment of the present invention.

FIG. 2B illustrates an exemplary linked list node structure according to an embodiment of the present invention.

FIG. 2C illustrates an exemplary linked list attribute structure according to an embodiment of the present invention.

FIG. 3A illustrates an exemplary XML string.

FIG. 3B is an exemplary flow diagram describing a method for tokenizing source XML according to an embodiment of the present invention.

FIGS. 3C and 3B are a flow diagram describing an exemplary method for generating a linked list node structure according to an embodiment of the present invention.

FIG. 3E illustrates exemplary linked list node structures for the exemplary XML string shown in FIG. 3A according to an embodiment of the present invention.

FIG. 4 is a flow diagram describing an exemplary method for determining whether an XML string is valid according to an embodiment of the present invention.

FIGS. 5A and 5B are a flow diagram describing an exemplary method for creating a linked list of attribute structures from a linked list node structure according to an embodiment of the present invention.

FIG. 5C illustrates an exemplary linked list attribute structure for the exemplary XML string in FIG. 3A according to an embodiment of the present invention.

FIG. 6A is a flow diagram describing an exemplary method for obtaining data from start and close linked list node structures according to an embodiment of the present invention.

FIG. 6B illustrates data being extracted from the exemplary XML string in FIG. 3A according to an embodiment of the present invention.

### DETAILED DESCRIPTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrases “in one embodiment” or “in an embodiment” appearing in various places throughout the specification are not necessarily all referring to the same embodiment.

Embodiments of the present invention are directed to a system and method for parsing XML that does not require large amounts of memory overhead. The present invention accomplishes this by using zero memory copies, thereby yielding a very efficient parser with a small footprint. Although embodiments of the present invention are described with respect to XML, other types of markup languages may also be applicable.

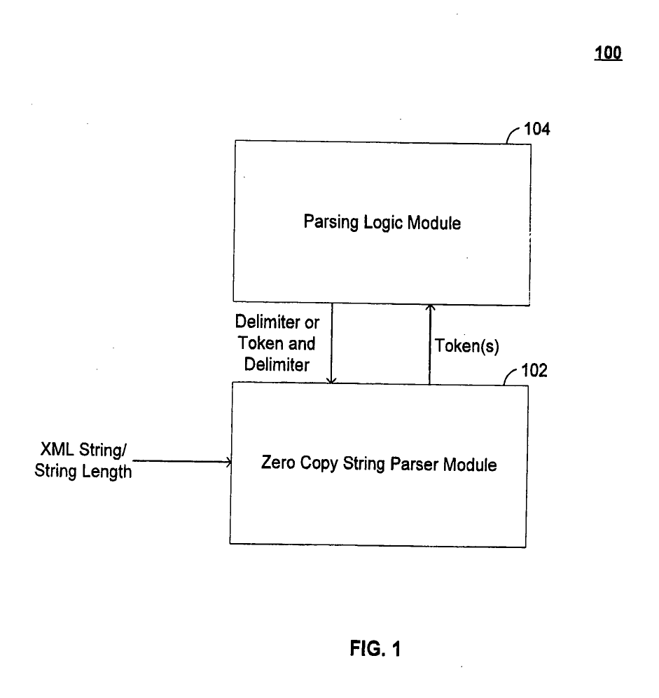

FIG. 1 is an exemplary block diagram illustrating a system 100 for parsing XML. System 100 comprises a zero copy string parser module 102 and a parser logic module 104. Zero copy string parser module 102 is coupled to parser logic module 104.

Zero copy string parser module 102 is responsible for parsing XML strings without copying any data. Zero copy string parser module 102 is a single pass parser, thus, an input string received from an application is only read once.

As shown in FIG. 1, parser logic module 104 is built on top of zero copy string parser module 102. Parser logic module 104 contains the logic required to parse an XML entity. Thus, parser logic module 104 interacts with zero copy string parser module 102 to parse XML strings without having to copy the XML string into memory.

Zero copy string parser module 102 receives an input string to parse and the length of the input string from an application. Parsing logic module 104 provides zero copy string parser module 102 with a delimiter to parse on, thereby enabling zero copy string parser module 102 to tokenize the string. Each token contains an index into the source XML string (i.e., input string), which represents its value, and a property depicting the length of the value. Once the string has been tokenized, linked list node structures are built using the tokens and linked list attribute structures are built using the linked list node structures. The node and attribute structures contain pointers into the source XML string. The linked list node and attribute structures are freed from memory while maintaining the pointers associated with the source XML string. Maintaining the pointers while deleting the structures prevents the XML string from having to be copied, thereby minimizing memory overhead.

After tokenizing the string, zero copy string parser module 102 will send each token to parsing logic module 104 to create the linked list node structures. Parsing logic module 104, upon receiving the tokens, will return one token at a time to zero copy string parser module 102 along with the length of the token and a delimiter. Zero copy string parser module 102 will then parse the token using that delimiter to obtain pointers for the linked list node structure. This process continues until all tokens have been properly parsed. Once the linked list node structures are created, the linked list node structures are used to create the linked list attribute structures to provide pointers to the attributes included in the XML string. Data within the XML string may also be extracted using pointers from the linked list node structures.

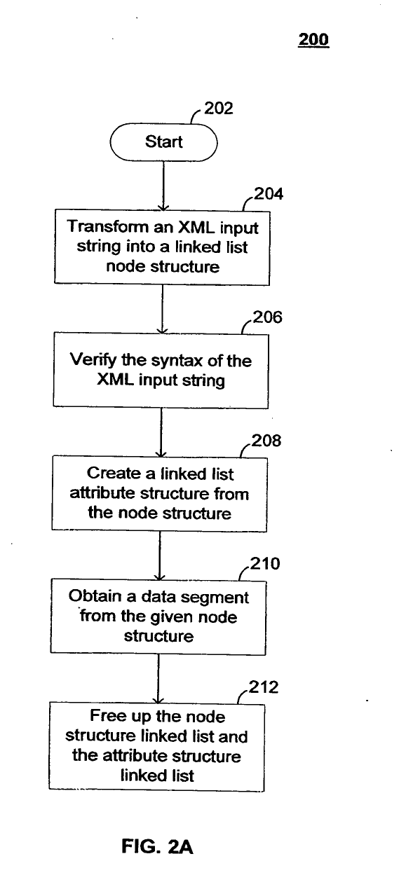

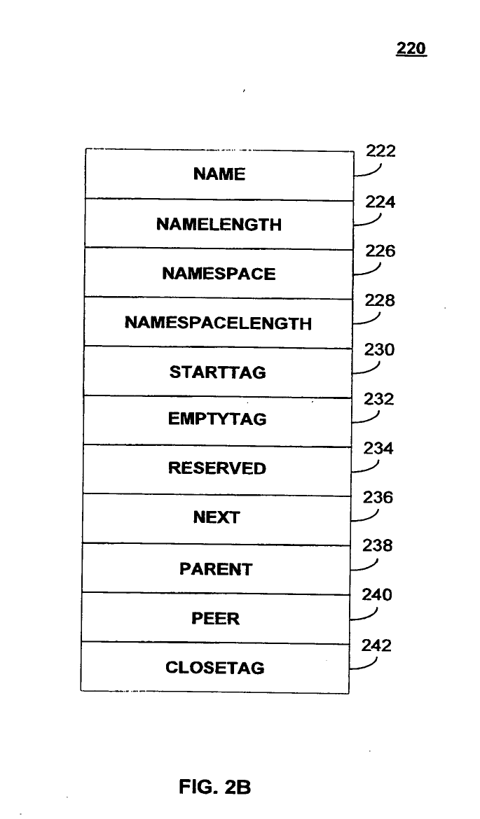

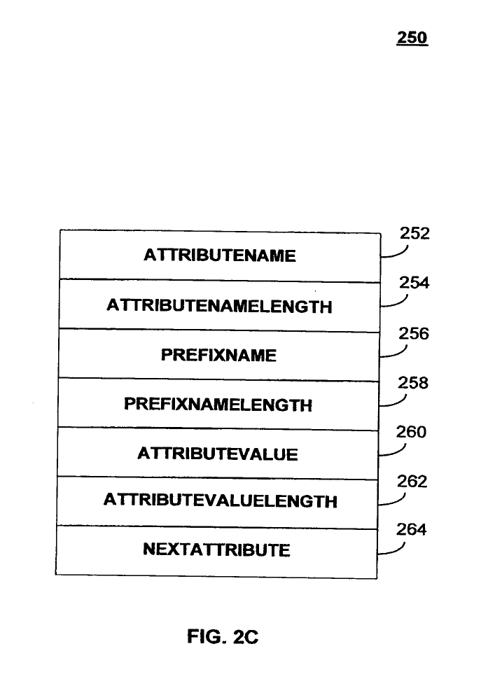

At least five delimiters are used to parse an XML string. The delimiters include, but are not limited to, an open bracket “<”, a space ““, a colon “:”, an equal sign “=”, and a close bracket “>”. Logic parser module 104 analyzes the tokens and provides zero copy string parser 102 with the appropriate delimiter to parse each token. The process of parsing XML strings will now be described with reference to FIG. 2A.

FIG. 2A is a flow diagram 200 describing an exemplary method for parsing XML strings according to an embodiment of the present invention. The invention is not limited to the embodiment described herein with respect to flow diagram 200. Rather, it will be apparent to persons skilled in the relevant art(s) after reading the teachings provided herein that other functional flow diagrams are within the scope of the invention. The process begins with block 202, where the process immediately proceeds to block 204.

In block 204, an XML string, input from an application into zero copy string parser module 102, is transformed into a linked list of node structures. Each element in the XML string is transformed into two node structures; one node structure for a start tag and one node structure for an end tag.

FIG. 2B illustrates an exemplary node structure 220 according to an embodiment of the present invention. Node structure 220 comprises a name field 222, a namelength field 224, a namespace field 226, a namespacelength field 228, a start tag field 230, an empty tag field 232, a reserved field 234, a next field 236, a parent field 238, a peer field 240, and a close tag field 242.

Name field 222 represents the name of an element tag. Namelength field 224 represents the length of the element tag name. Namespace field 226 represents the name of any prefix associated with the element tag. Namespacelength field 228 represents the length of any prefix associated with the element tag.

Start tag field 230 represents a flag that, when set, indicates that the element tag is a start tag. When start tag field 230 is clear, the tag is a close tag. Empty tag field 232 represents a flag that, when set, indicates that the element tag is an empty tag. An empty tag is a tag that stands by itself. In other words, the empty tag does not enclose any content. The empty tag ends with a slash and a close bracket (i.e., “/>”) instead of a close bracket (i.e., “>”).

Reserved field 234 may represent the position at the next close bracket (i.e., “>”), if the tag is a start tag. Reserved field 234 may represent the position of the first open bracket (i.e., “<”), if the tag is a close tag. Next field 236 represents a pointer to the next node structure.

Parent field 238 represents a pointer to an open element of a parent element. A parent element is an element surrounding a nested element. Peer field 240 represents a pointer to an open element of a peer element. A peer element is an element is co-located with another element. In other words, peer elements are on the same level. For example, child elements having the same parent element are peer elements. Close tag field 242 represents a pointer to a close element of the element tag.

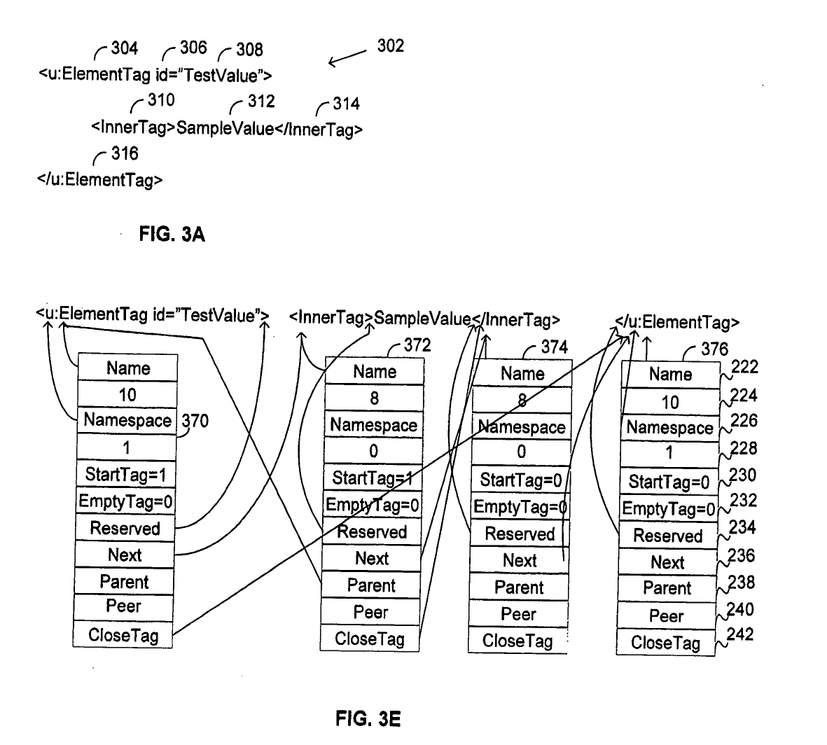

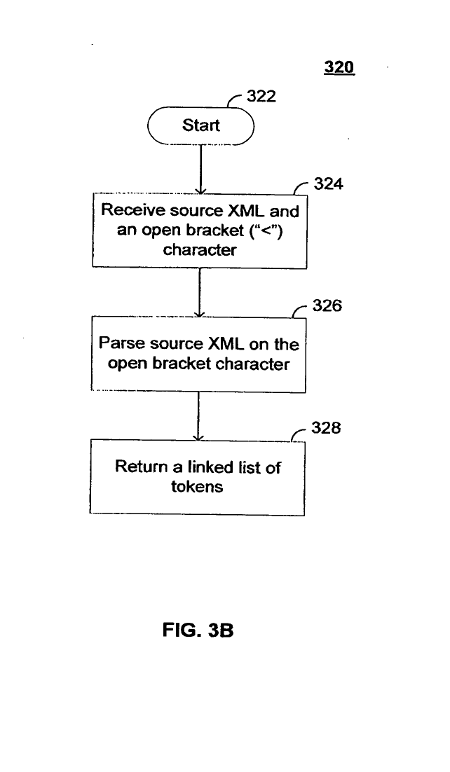

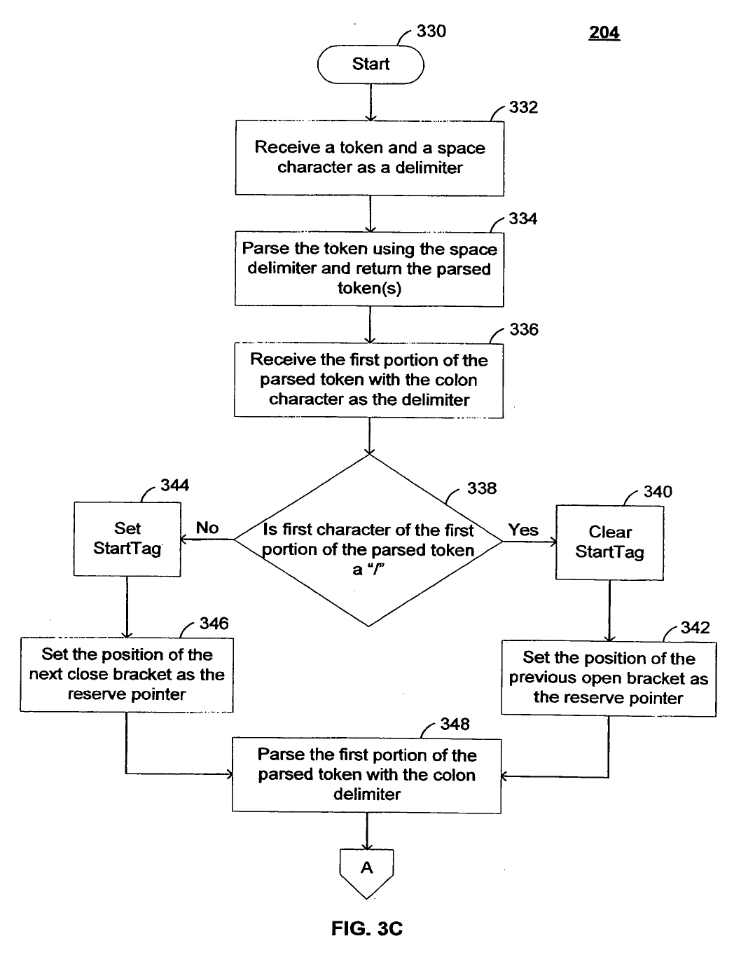

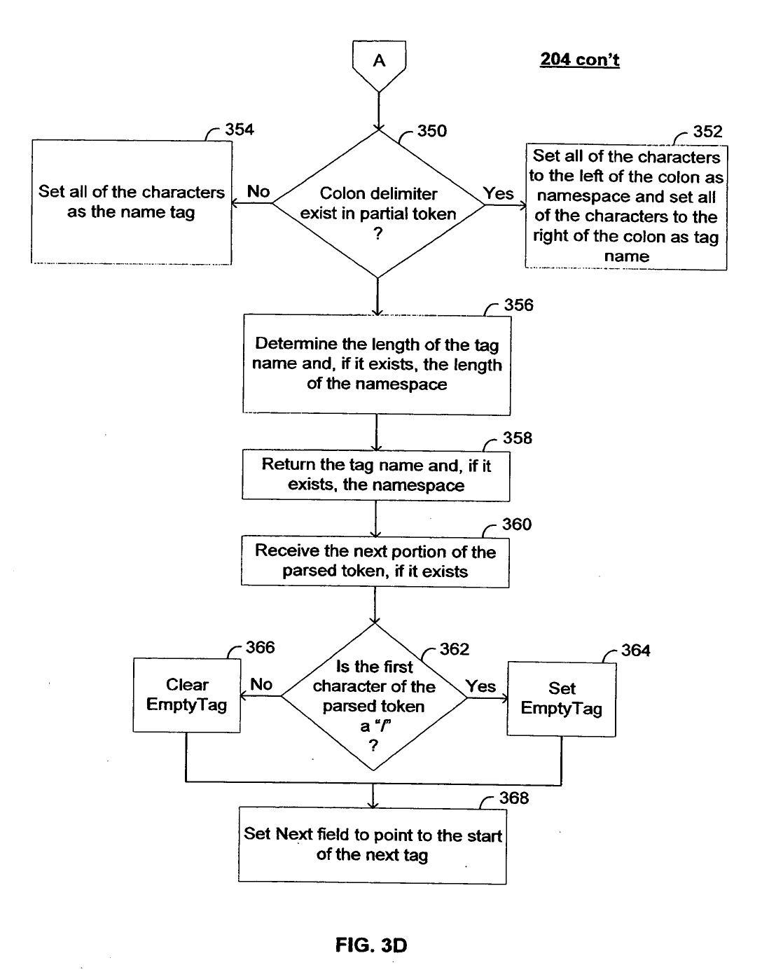

Returning to block 204 in FIG. 2, certain fields within node structure 220 are populated initially. These fields include name field 222, namelength field 224, namespace field 226, namespacelength field 228, start tag field 230, empty tag field 232, reserved field 234, and next field 236. Name, namespace, reserved, and next are pointers into the source XML string. A method for determining a linked list node structure from an XML string is further described below with reference to FIGS. 3B-3D.

In block 206, the syntax of the XML input string is verified to determine whether the input string is valid. This is accomplished by verifying whether each element is opened and closed correctly. A constraint for XML documents is that they be well formed. Certain rules determine whether an XML document is well formed. One such rule is that every start tag have a closing tag, and the closing tag must have the same name, same namespace, etc. as the start tag. For example, a start tag named <A:ElementTag> must be terminated by a close tag named </A:ElementTag>. Also, all tags must be completely nested. For example, one can have <ElementTag> . . . <InnerTag> . . . </InnerTag> . . . </ElementTag>, but not <ElementTag> . . . <InnerTag> . . . </ElementTag> . . . </InnerTag>.

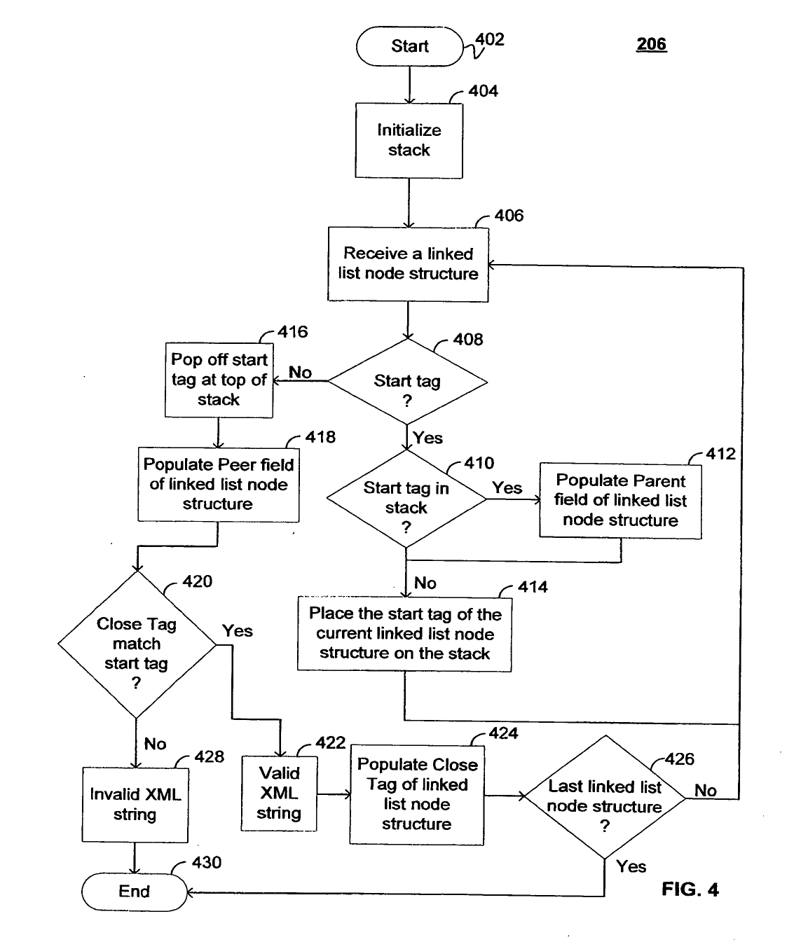

While the XML string is being verified, the remaining fields of the linked list node structure are populated. These fields include parent field 238, peer field 240 and close tag field 242. A method for verifying the syntax of the XML string is described below with reference to FIG. 4.

In block 208, a linked list of attribute structures is created from a linked list node structure. An exemplary linked list attribute structure 250 is illustrated in FIG. 2C. Linked list attribute structure 250 comprises an attribute name field 252, an attribute name length field 254, an attribute value field 260, a prefix name field 256, a prefix name length field 258, an attribute value length field 262, and a next attribute field 264.

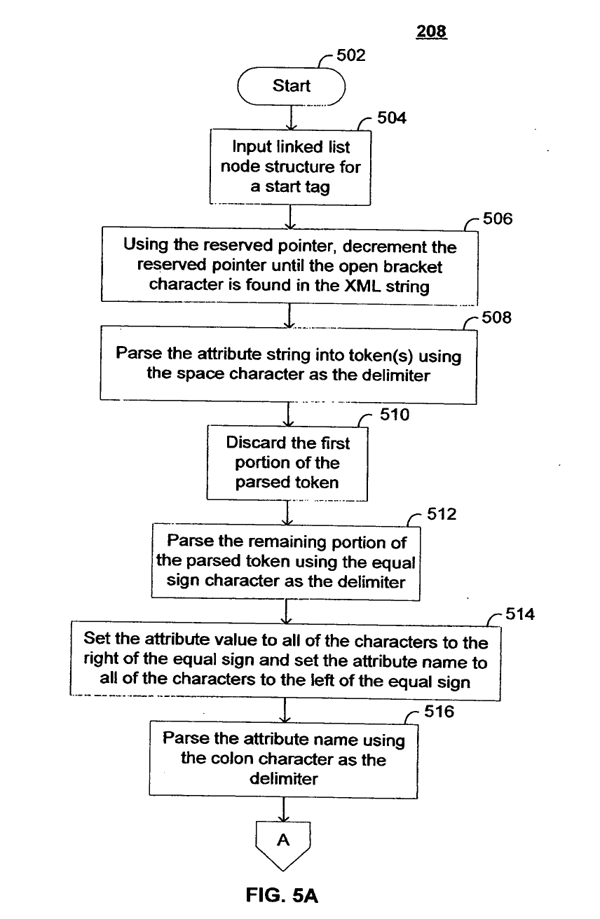

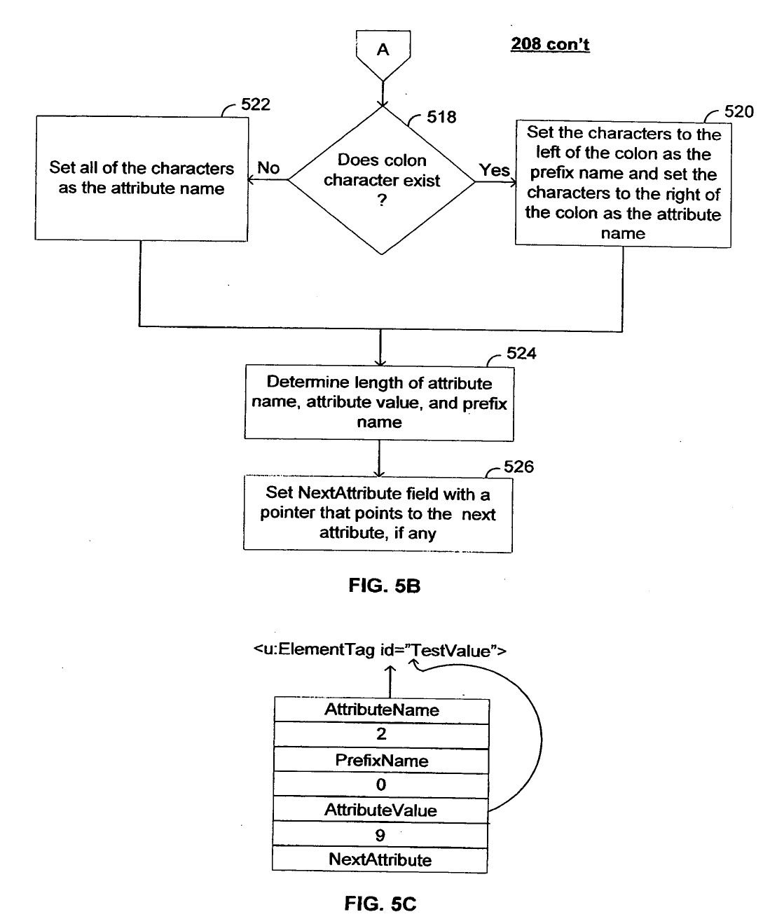

Attribute name field 252 represents the name of an attribute. Attribute name length field 254 represents the length of the attribute name. Prefix name field 256 represents the name of the prefix. Prefix name length field 258 represents the length of the prefix name. Attribute value field 260 represents the value of the attribute. Attribute value length field 262 represents the length of the attribute value. Next attribute field 264 represents a pointer to the next attribute, if there are any. A method for creating a linked list attribute structure is described below with reference to FIGS. 5A and 5B.

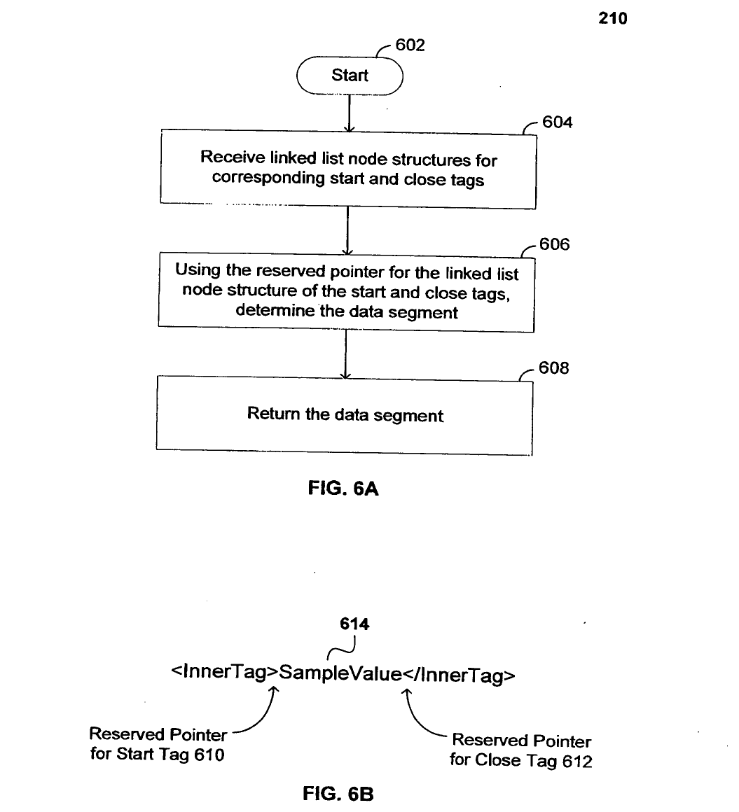

Returning to FIG. 2A, in block 210, the data segment from a given node structure is obtained. In one embodiment, the data of a given element may be a simple string. In one embodiment, the data of a given element may be an XML subtree. The determination of the data segment is described below with reference to FIG. 6A.

In block 212, the node structure linked lists and the attribute structure linked lists are then cleaned up or freed, leaving only the pointers to the original XML string.

Prior to describing methods for creating a linked list node structure and a linked list attribute structure, an exemplary XML string that will be referred to when describing these methods will be described. FIG. 3A illustrates an exemplary XML string 302. XML string 302 includes a start tag 304 named “u:ElementTag”, an attribute 306 named “id”, an attribute value 308 named “TestValue”, a start tag 310 named “InnerTag”, textual data 312 named “SampleValue”, a close tag 314 named “InnerTag”, and a close tag 316 named u:ElementTag”. Each start tag 304 and 310 has a matching close tag 316 and 314, respectively. Thus, each start tag is identified by an open bracket “<” and each close tag is identified by an open bracket followed by a slash “</”.

FIG. 3B is an exemplary flow diagram 320 describing a method for tokenizing source XML according to an embodiment of the present invention. The invention is not limited to the embodiment described herein with respect to flow diagram 320. Rather, it will be apparent to persons skilled in the relevant art(s) after reading the teachings provided herein that other functional flow diagrams are within the scope of the invention. The process begins with block 322, where the process immediately proceeds to block 324.

In block 324, an XML string from an application and an open bracket (“<”) delimiter from parsing logic 104 are input into zero copy string parser module 102. Zero copy string parser module 102 parses the XML string using the open bracket delimiter to obtain a list of tokens (block 326). The list of tokens represent the start of each tag in the XML input string. Using exemplary XML string 302 from FIG. 3A, the following list of tokens would be returned: (1) u:ElementTag; (2) InnerTag; (3) /InnerTag; and (4) /u:ElementTag. Each token is representative of an index into the source XML string, which represent its value, and a property depicting the length of the value.

In block 328, the list of tokens is returned to parser logic module 104. Each token from the list of tokens is used to create a separate linked list node structure, which is further described with reference to FIGS. 3C and 3D.

FIGS. 3C and 3D are a flow diagram 204 describing an exemplary method for generating a linked list node structure according to an embodiment of the present invention. The invention is not limited to the embodiment described herein with respect to flow diagram 204. Rather, it will be apparent to persons skilled in the relevant art(s) after reading the teachings provided herein that other functional flow diagrams are within the scope of the invention. The process begins with block 330 in FIG. 3C where the process immediately proceeds to block 332.

In block 332, a token and a space delimiter (i.e., “) are input into zero copy string parser module 102 from parser logic module 104.

In block 334, the token is parsed on the space (i.e., “ ”) delimiter to identify the tag name for the structure. For example, using the token u:ElementTag id=“TestValue”, zero copy string parser module 102 will parse the token using the space delimiter and return two parts of the token to parser logic module 104, i.e., the first part is u:ElementTag; and the second part is id=“TestValue”. The first part of the token, u:ElementTag, always comprises the tag name. The second part of the token, id=“TestValue”, may comprise the attribute(s). For tokens that do not contain a space, zero copy string parser module 102 will return the token as is. Since the return token is the first token in this case, it comprises the tag name.

In block 336, parser logic module 104 will send the first part of the token comprising the tag name to zero copy string parser 102 along with the colon character (i.e., “:”) delimiter. The colon delimiter is used to extract the namespace from the local name of the tag.

In decision block 338, it is determined whether the first character of the token comprising the tag name begins with “/”. If the first character of the token comprising the tag name begins with “/”, the tag is a close tag. In this instance, the start tag is cleared (block 340) and the position of the first open bracket (“<”) is set as the reserved pointer (342). The process then proceeds to block 348.

Returning to decision block 338, if the first character of the token comprising the tag name does not begin with “/”, then the tag is a start tag. In this instance, the start tag is set (block 344) and the position at the next close bracket (“>”) is set as the reserved pointer (block 346). The process then proceeds to block 348.

In block 348, the token comprising the tag name is parsed using the colon delimiter.

In decision block 350 of FIG. 3D, it is determined whether the colon delimiter is found within the token comprising the tag name. If the colon delimiter is found within the token, then all characters to the left of the colon are set as the namespace and all characters to the right of the colon are set as the local name of the element or tag name (block 352). For example, start tag u:ElementTag, when parsed, will indicate “u” as the namespace prefix and “ElementTag” as the local tag name. If the colon delimiter is not found within the token, then all of the characters in the token represent the tag name (block 354).

In block 356, the length of the tag name and, if it exists, the length of the namespace are determined.

In block 358, the tag name and the namespace, if it exists, are returned to parser logic module 104. The second part of the token is then passed to zero copy string parser module 102 in block 360.

In decision block 362, it is determined whether the first character of the second part of the token is a “/”. If it is determined that the first character of the second portion of the first token is a “/”, then the tag is an empty tag, and the process proceeds to block 364.

In block 364, empty tag field 232 is set. The process then proceeds to block 368.

Returning to decision block 362, if it is determined that the first character of the second portion of the first token is not a “/”, then the process proceeds to block 366.

In block 366, empty tag field 232 is cleared, and the process proceeds to block 368.

In block 368, next field 236 is set as a pointer to the start of the next tag. For example, in exemplary XML string 302, next field 236 for start tag u:ElementTag is a pointer to InnerTag.

FIG. 3E illustrates exemplary linked list node structures for exemplary XML string 302 shown in FIG. 3A according to an embodiment of the present invention. A linked list node structure for each start and close tag in XML string 302 is shown. Arrows from the fields of the linked list node structures indicate pointers to the actual XML string.

A first linked list node structure 370 is representative of start tag u:ElementTag. The tag name is ElementTag. ElementTag is 10 characters in length as indicated in name length field 224. The namespace prefix is u, and is one (1) character in length as indicated in namespace length field 228. The start tag is set. The empty tag is clear. Reserved field 234 points to the close bracket of start tag u:ElementTag. Next field 236 points to the next tag, which is InnerTag. Close tag field 242 points to the close tag of u:ElementTag, which is /u:ElementTag.

A second linked list node structure 372 is representative of start tag InnerTag. The tag name is InnerTag. InnerTag is 8 characters in length as indicated in field 224. InnerTag does not have a namespace (which is indicated by the lack of a colon character in InnerTag). Thus, the namespace length is zero (0) as indicated by field 228. The start tag is set. The empty tag is clear. Reserved field 234 points to the close bracket of start tag InnerTag. Next field 236 points to the next tag, which is /InnerTag. The parent of InnerTag is u:ElementTag. And close tag field 242 points to the close tag of InnerTag, which is /InnerTag.

A third linked list node structure 374 is representative of close tag /InnerTag. The tag name is InnerTag, which is 8 characters in length. As previously indicated, InnerTag does not have a namespace, thus, the namespace length is zero. The start tag is clear. The empty tag is clear. Reserved field 234 points to the open bracket of close tag /InnerTag. Next field 236 points to the next tag, which is /u:ElementTag. Since node structure 374 represents a close tag, remaining fields 238, 240, and 242 are empty.

A fourth linked list node structure 376 is representative of close tag /u:ElementTag. The tag name is ElementTag, which is 10 characters in length. The namespace is u, and is one (1) character in length. The start tag is clear. The empty tag is clear. Reserved field 234 points to the open bracket of close tag /u:ElementTag. Since node structure 376 represents a close tag and is the last tag in XML string 302, next field 236, parent field 238, peer field 240 and close tag filed 242 are empty.

FIG. 4 is an exemplary flow diagram 206 describing a method for determining whether the XML string is valid according to an embodiment of the present invention. The invention is not limited to the embodiment described herein with respect to flow diagram 206. Rather, it will be apparent to persons skilled in the relevant art(s) after reading the teachings provided herein that other functional flow diagrams are within the scope of the invention. The process begins with block 402, where the process immediately proceeds to block 404.

In block 404, a stack is initialized. This is accomplished by clearing the stack.

In block 406, a linked list node structure is received. In decision block 408, it is determined whether the linked list node structure represents a start tag. If it is determined that the linked list node structure represents a start tag, then the process proceeds to decision block 410.

In decision block 410, it is determined whether a start tag already exists in the stack. If a start tag already exists in the stack, then parent field 238 is populated with a pointer to the current item at the top of the stack (block 412). For example, using XML string 302 in FIG. 3A, ElementTag is the parent of InnerTag. This is also indicated in linked list node structure 372 of FIG. 3E. The process then proceeds to block 414.

Returning to block 410, if it is determined that a start tag does not exist in the stack (i.e., the stack is empty), then the process proceeds to block 414.

In block 414, the start tag of the current linked list node structure is placed on the stack. The process then returns back to block 406 to receive the next linked list node structure.

Returning to block 408, if it is determined that the linked list node structure is a close tag, then the process proceeds to block 416. In block 416, the start tag at the top of the stack is popped off of the stack.

In block 418, peer field 240 of the popped start tag is populated with the next field pointer 236 of the current close tag. The following XML structure illustrates a peer:

<u:ElementTag id=””TestValue”>

<InnerTag>SampleValue</InnerTag>
<AnotherTag>AnotherValue</AnotherTag>

</u:ElementTag>

In the above example, InnerTag and AnotherTag are peers. InnerTag and AnotherTag are also both children of u:ElementTag. The process then proceeds to decision block 420.

In decision block 420, it is determined whether the popped off start tag matches the current close tag. If the popped off start tag does match the current close tag, then the XML string is considered to be a valid string (block 422). In other words, the syntax of the XML string is correct at this point. Close tag field 242 is then populated with the current close tag (block 424).

In decision block 426, it is determined whether the current linked list node structure is the last structure for the current XML string. If it is determined that the current linked list node structure is not the last structure for the current XML string, then the process proceeds back to block 406 to receive the next linked list node structure.

Returning to decision block 426, if it is determined that the current linked list node structure is the last structure for the current XML string, then the process proceeds to block 430, where the process ends.

Returning to decision block 420, if it is determined that the popped off start tag does not match the current close tag, then the XML string is considered to be an invalid string (block 428). The process then proceeds to block 430, where the process immediately ends.

When an application desires access to the attributes contained in a given element, the application can give zero copy string parser 102 the linked list node structure. Zero copy string parser 102 will use the reserved pointers of the element to parse the attributes. Zero copy string parser 102 will return a linked list of AttributeStructures, which contain pointers into the original string to represent the attribute name and attribute value, as well as properties depicting the length of these values. Utilizing this method for parsing attributes results in less overhead for the majority case when attribute parsing is not required by the application. Also, when attributes are parsed, there are zero memory copies which results in higher performance and less resource use as compared to conventional parsing methods.

FIGS. 5A and 5B are a flow diagram 208 describing an exemplary method for creating a linked list of attribute structures from a linked list node structure according to an embodiment of the present invention. The invention is not limited to the embodiment described herein with respect to flow diagram 208. Rather, it will be apparent to persons skilled in the relevant art(s) after reading the teachings provided herein that other functional flow diagrams are within the scope of the invention. The process begins with block 502 in FIG. 5A, where the process immediately proceeds to block 504.

In block 504, a linked list node structure for a start tag is input into zero copy string parser 102.

In block 506, using the position of the reserved pointer from the linked list node structure, the reserved pointer is decremented until the open bracket character is found in the XML string. The information between the open bracket character and the reserved pointer defines the attribute string.

In block 508, the attribute string is parsed into tokens using the space character. As previously indicated, the first token is the tag name. The remaining token or tokens, if any, are the actual attributes. In block 510, the first token is discarded since it is not an attribute.

In block 512, the remaining token or tokens are parsed using the equal sign character to separate the attribute name from the attribute value. The attribute name is equivalent to all of the characters to the left of the equal sign and the attribute value is equivalent to all of the characters to the right of the equal sign (block 514).

In block 516, the attribute name is parsed using the colon sign (i.e., “:”) to obtain prefix information, if there is any. In decision block 518 in FIG. 5B, it is determined whether a colon character is found within the attribute name. If a colon character is found, everything to the left of the colon is set as the prefix name and everything to the right of the colon is set as the attribute name (block 520). If it is determined that the colon character does not exist within the attribute name, then the entire token is set as the attribute name in block 522.

In block 524, the length of the attribute name, attribute value, and prefix name are determined. If no prefix name exists, then the length of the prefix name is set to zero.

In block 526, next attribute field 264 is set as a pointer to the next attribute, if another attribute exists in the XML string.

FIG. 5C illustrates an exemplary linked list attribute structure 530 for exemplary XML string 302 in FIG. 3A according to an embodiment of the present invention. As shown in FIG. 5C, only one attribute, i.e., id=“TestValue”, is included in XML string 302. Pointers within linked list attribute structure 530 are indicated using arrows that point to a location within XML string 302. The remaining fields 254, 258, and 262 are indicative of the lengths of the attribute name, prefix name, and attribute value, respectively. Since XML string 302 only contains one attribute, next attribute field 264 does not include a pointer to a location within XML string 302.

When an application desires access to data contained within an element, In one embodiment, the application will give the start linked list node structure to zero copy string parser module 102. Using the pointers in the start linked list node structure, zero copy string parser module 102 will locate the close tag. In another embodiment, the application will give the start and close linked list node structures to zero copy string parser module 102. Zero copy string parser module 102 will use the reserved pointers of the start and close tag for the structures passed to parser 102 to determine the data segment and then return the data segment back to the application.

FIG. 6A is a flow diagram 210 describing an exemplary method for obtaining a data segment from start and close linked list node structures according to an embodiment of the present invention. The invention is not limited to the embodiment described herein with respect to flow diagram 210. Rather, it will be apparent to persons skilled in the relevant art(s) after reading the teachings provided herein that other functional flow diagrams are within the scope of the invention. The process begins with block 602, where the process immediately proceeds to block 604.

In block 604, both the linked list node structure for a corresponding start and close tag are received.

In block 606, using the reserved pointers of the start and close tags, the data segment is determined. The reserved pointer for the start tag points to the close bracket and the reserved pointer for the close tag points to the open bracket. Thus, the data segment is everything in between these two reserved pointers. FIG. 6B illustrates data being extracted from the exemplary XML string in FIG. 3A according to an embodiment of the present invention. A reserved pointer 610 for the start tag of InnerTag is pointing to the close bracket of InnerTag while a reserved pointer 612 for the close tag of /InnerTag is pointing to the open or start bracket of /InnerTag. Thus, SampleValue 614 is the data segment since it lies between reserved pointers 610 and 612, respectively.

In block 608, the data segment is returned to the application.

Certain aspects of embodiments of the present invention may be implemented using hardware, software, or a combination thereof and may be implemented in one or more computer systems or other processing systems. In fact, in one embodiment, the methods may be implemented in programs executing on programmable machines such as mobile or stationary computers, personal digital assistants (PDAs), set top boxes, cellular telephones and pagers, and other electronic devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that embodiments of the invention may be practiced with various computer system configurations, including multiprocessor systems, minicomputers, mainframe computers, and the like. Embodiments of the present invention may also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the methods described herein. Alternatively, the methods may be performed by specific hardware components that contain hardwired logic for performing the methods, or by any combination of programmed computer components and custom hardware components. The methods described herein may be provided as a computer program product that may include a machine readable medium having stored thereon instructions that may be used to program a processing system or other electronic device to perform the methods. The term “machine readable medium” or “machine accessible medium” used herein shall include any medium that is capable of storing or encoding a sequence of instructions for execution by the machine and that causes the machine to perform any one of the methods described herein. The terms “machine readable medium” and “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While various embodiments of the present invention have been described above, it should be understood that they have been presented by way of example only, not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1. A method for separating markup language statements, comprising:
transforming an input string into linked list node structures;
verifying the input string syntax;
creating a linked list attribute structure from the linked list node structures that comprise attributes;
obtaining a data segment from the linked list node structures that comprise data; and
freeing the linked list node structures and attribute structures.

2. The method of claim 1, wherein freeing the linked list node structures and attribute structures deletes the linked list node and attribute structures while maintaining pointers, defined within the linked list node and attribute structures, into the input string that define data and attributes within each of a plurality of elements contained within the input string.

3. The method of claim 2, wherein the pointers within the linked list node structures comprise one or more pointers to a tag name, a namespace, a reserved position, a next tag, a parent element, a peer element, and a close tag.

4. The method of claim 2, wherein pointers within the linked list attribute structures comprise one or more pointers to an attribute name, an attribute value, a prefix name, and a next attribute.

5. The method of claim 3, wherein the pointer to the reserved position comprises a pointer to a next close bracket for a start tag and a pointer to an open bracket for a close tag.

6. The method of claim 1, wherein transforming an input string into linked list node structures comprises:
receiving the input string and an open bracket character as a delimiter;
parsing the input string on the open bracket delimiter;
returning a linked list of tokens, wherein each token in the linked list is parsed to provide one linked list node structure.

7. The method of claim 6, wherein parsing each token in the linked list to provide one linked list node structure comprises:
determining whether the token begins with a slash (“/”);
setting a start tag field in the linked list node structure if the token does not begin with the slash and clearing the start tag field if the token does begin with the slash;
parsing the token on a space character as the delimiter to separate the token into a first portion and second portion, if the space character is found in the token;
if the space character is found within the token,
setting a namespace pointer in the linked list node structure to a first character in the first portion of the token for a namespace, the length of the namespace spanning from a first character in the first portion of the token to a character preceeding the colon in the first portion of the token;
setting a tag name pointer in the linked list node structure to a character to the right of the colon in the first portion of the token for a tag name, the length of the tag name spanning from the character to the right of the colon to the last character of the first portion of the token;
if the space character is not found within the token,
setting the tag name pointer in the linked list node structure to the characters in the token, the length of the tag name being the length of the token;
setting the namespace pointer in the linked list node structure as a null pointer, the length of the namespace being zero; and
setting a next field pointer in the linked list node structure to point to the beginning of the next token.

8. The method of claim 7, further comprising:
setting a reserved pointer in the linked list node structure to point to a close bracket at the end of the token if the token is a start tag and setting the reserved pointer to point to an open bracket at the beginning of the token if the token is a close tag.

9. The method of claim 7, further comprising:
determining if a first character of the second portion of the token begins with the slash;
setting an empty tag field in the linked list node structure if the second portion of the token begins with the slash; and
clearing the empty tag field in the linked list node structure if the second portion of the token does not begin with the slash.

10. The method of claim 1, wherein verifying the input string syntax comprises:
initializing a stack;
receiving a linked list node structure for an input string;
determining if the linked list node structure represents one of a start tag and a close tag;
if the linked list node structure represents a current start tag,
populating a parent field in the linked list node structure with a pointer to the start tag at the top of the stack, if the stack is not empty; and
placing the current start tag onto the stack;
if the linked list node structure represents a current close tag,
popping off the start tag at the top of the stack;
populating a peer field in the linked list node structure with a pointer to a next field pointer of the current close tag;
determining if the current close tag matches the start tag popped off the stack;
if the current close tag does not match the start tag popped off the stack, indicating the input string as being invalid; and
if the current close tag does match the start tag popped off the stack, indicating the input string as being valid and populating a close tag of the linked list node structure with the current close tag; and
if the input string is valid and if the linked list node structure is not the last linked list node structure for the input string, then repeating the above process using the next linked list node structure from the input string, excluding the initialization of the stack.

11. The method of claim 1, wherein creating a linked list attribute structure from the linked list node structures that comprise attributes comprises:
receiving a linked list node structure for a start tag;
using a reserved pointer in the linked list node structure, decrement the position of the reserved pointer until an open bracket character is found in the input string, wherein the all characters between the open bracket character and the reserved pointer represent an attribute string;
parsing the attribute string using a space character as a delimiter to provide a first portion of the attribute string and a second portion of the attribute string;
discarding the first portion of the attribute string;
parsing the second portion of the attribute string using an equal sign as the delimiter;
setting an attribute value pointer in the linked list attribute structure to the first character after the equal sign character of the second portion of the attribute string, an attribute value length spanning the first character of the second portion of the attribute string to the end of the second portion of the attribute string;
parsing the first portion of the attribute string using a colon as the delimiter;
if the colon character is found in the first portion of the attribute string,
setting a prefix name pointer in the linked list attribute structure to the first character in the first portion of the attribute string, the length of a prefix name spanning the first character in the first portion of the attribute string to a character preceeding the colon in the first portion of the attribute string;
setting an attribute name pointer in the linked list attribute structure to a first character after the colon in the first portion of the attribute string, the length of an attribute name spanning from the first character after the colon in the first portion of the attribute string to the last character of the first portion of the attribute string;
if the colon character is not found in the first portion of the attribute string,
setting the prefix name pointer in the linked list attribute structure as a null pointer, wherein the length of the prefix name is zero;
setting the attribute name pointer in the linked list attribute structure as the first character of the first portion of the attribute string, the length of the attribute name being the length of the first portion of the attribute string; and
setting a next attribute field in the linked list attribute structure to point to the next attribute in the input string.

12. The method of claim 1, wherein obtaining a data segment from the linked list node structures that comprise data comprises:
receiving the linked list node structures for corresponding start and close tags; and
using reserved pointers for the linked list node structures of the start and close tags to determine the data segment, wherein the data segment comprises the data between the reserved pointer of the start tag and the reserved pointer of the close tag.

13. The method of claim 1, wherein the input string comprises an XML (extensible markup language) input string.

14. An article comprising: a storage medium having a plurality of machine accessible instructions, wherein when the instructions are executed by a processor, the instructions provide for transforming an input string into linked list node structures;
verifying the input string syntax;
creating a linked list attribute structure from the linked list node structures that comprise attributes;
obtaining a data segment from the linked list node structures that comprise data; and
freeing the linked list node structures and attribute structures.

15. The article of claim 14, wherein freeing the linked list node structures and attribute structures deletes the linked list node and attribute structures while maintaining pointers, defined within the linked list node and attribute structures, into the input string that define data and attributes within each of a plurality of elements contained within the input string.

16. The article of claim 15, wherein the pointers within the linked list node structures comprise one or more pointers to a tag name, a namespace, a reserved position, a next tag, a parent element, a peer element, and a close tag.

17. The article of claim 15, wherein pointers within the linked list attribute structures comprise one or more pointers to an attribute name, an attribute value, a prefix name, and a next attribute.

18. The article of claim 16, wherein the pointer to the reserved position comprises a pointer to a next close bracket for a start tag and a pointer to an open bracket for a close tag.

19. The article of claim 14, wherein instructions for transforming an input string into linked list node structures comprises instructions for:
receiving the input string and an open bracket character as a delimiter;
parsing the input string on the open bracket delimiter;
returning a linked list of tokens, wherein each token in the linked list is parsed to provide one linked list node structure.

20. The article of claim 19, wherein instructions for parsing each token in the linked list to provide one linked list node structure comprises instructions for:
determining whether the token begins with a slash (”/”);
setting a start tag field in the linked list node structure if the token does not begin with the slash and clearing the start tag field if the token does begin with the slash;
parsing the token on a space character as the delimiter to separate the token into a first portion and second portion, if the space character is found in the token;
if the space character is found within the token,
setting a namespace pointer in the linked list node structure to a first character in the first portion of the token for a namespace, the length of the namespace spanning from a first character in the first portion of the token to a character preceeding the colon in the first portion of the token;
setting a tag name pointer in the linked list node structure to a character to the right of the colon in the first portion of the token for a tag name, the length of the tag name spanning from the character to the right of the colon to the last character of the first portion of the token;
if the space character is not found within the token,
setting the tag name pointer in the linked list node structure to the characters in the token, the length of the tag name being the length of the token;
setting the namespace pointer in the linked list node structure as a null pointer, the length of the namespace being zero; and
setting a next field pointer in the linked list node structure to point to the beginning of the next token.

21. The article of claim 20, further comprising instructions for:
setting a reserved pointer in the linked list node structure to point to a close bracket at the end of the token if the token is a start tag and setting the reserved pointer to point to an open bracket at the beginning of the token if the token is a close tag.

22. The article of claim 20, further comprising instructions for:
determining if a first character of the second portion of the token begins with the slash;
setting an empty tag field in the linked list node structure if the second portion of the token begins with the slash; and
clearing the empty tag field in the linked list node structure if the second portion of the token does not begin with the slash.

23. The article of claim 14, wherein instructions for verifying the input string syntax comprises instructions for:
initializing a stack;
receiving a linked list node structure for an input string;
determining if the linked list node structure represents one of a start tag and a close tag;
if the linked list node structure represents a current start tag,
populating a parent field in the linked list node structure with a pointer to the start tag at the top of the stack, if the stack is not empty; and
placing the current start tag onto the stack;
if the linked list node structure represents a current close tag,
popping off the start tag at the top of the stack;
populating a peer field in the linked list node structure with a pointer to a next field pointer of the current close tag;
determining if the current close tag matches the start tag popped off the stack;
if the current close tag does not match the start tag popped off the stack, indicating the input string as being invalid; and
if the current close tag does match the start tag popped off the stack, indicating the input string as being valid and populating a close tag of the linked list node structure with the current close tag; and
if the input string is valid and if the linked list node structure is not the last linked list node structure for the input string, then repeating the above process using the next linked list node structure from the input string, excluding the initialization of the stack.

24. The article of claim 14, wherein instructions for creating a linked list attribute structure from the linked list node structures that include attributes comprises instructions for:
receiving a linked list node structure for a start tag;
using a reserved pointer in the linked list node structure, decrement the position of the reserved pointer until an open bracket character is found in the input string, wherein the all characters between the open bracket character and the reserved pointer represent an attribute string;
parsing the attribute string using a space character as a delimiter to provide a first portion of the attribute string and a second portion of the attribute string;
discarding the first portion of the attribute string;
parsing the second portion of the attribute string using an equal sign as the delimiter;
setting an attribute value pointer in the linked list attribute structure to the first character after the equal sign character of the second portion of the attribute string, an attribute value length spanning the first character of the second portion of the attribute string to the end of the second portion of the attribute string;
parsing the first portion of the attribute string using a colon as the delimiter;
if the colon character is found in the first portion of the attribute string,
setting a prefix name pointer in the linked list attribute structure to the first character in the first portion of the attribute string, the length of a prefix name spanning the first character in the first portion of the attribute string to a character preceeding the colon in the first portion of the attribute string;
setting an attribute name pointer in the linked list attribute structure to a first character after the colon in the first portion of the attribute string, the length of an attribute name spanning from the first character after the colon in the first portion of the attribute string to the last character of the first portion of the attribute string;
if the colon character is not found in the first portion of the attribute string,
setting the prefix name pointer in the linked list attribute structure as a null pointer, wherein the length of the prefix name is zero;
setting the attribute name pointer in the linked list attribute structure as the first character of the first portion of the attribute string, the length of the attribute name being the length of the first portion of the attribute string; and
setting a next attribute field in the linked list attribute structure to point to the next attribute in the input string.

25. The article of claim 14, wherein instructions for obtaining a data segment from the linked list node structures that include data comprises instructions for:
receiving the linked list node structures for corresponding start and close tags; and
using reserved pointers for the linked list node structures of the start and close tags to determine the data segment, wherein the data segment comprises the data between the reserved pointer of the start tag and the reserved pointer of the close tag.

26. The article of claim 14, wherein the input string comprises an XML (extensible markup language) input string.

27. A system for separating markup language statements, comprising:
a zero copy string parser; and
a logic parser coupled to the zero copy string parser,
wherein the zero copy string parser and the logic parser interact to parse an input string from an application without copying the input string into memory.

28. The system of claim 27, wherein the zero copy string parser comprises a single pass parser.

29. The system of claim 27, wherein the logic parser comprises logic required to parse an XML (extensible Markup Language) string.

30. The system of claim 27, wherein the input string includes a length associated with the input string, and the logic parser provides a delimiter to the zero copy string parser to enable the zero copy string parser to parse the input string into one or more linked list node structures.

31. The system of claim 30, wherein the one or more linked list node structures include pointers to the input string to enable the zero copy string parser to further parse the input string using the pointers to create linked list attribute structures, the linked list attribute structures comprising additional pointers to one or more attributes found within the input string.

32. The system of claim 30, wherein the one or more linked list node structures include reserve pointers to the input string to enable the zero copy string parser to further parse the input string to obtain data found within an element included in the input string.
